(19) United States
(12) Patent Application Publication
(10) Pub. No.: US 2021/0170531 A1
(43) Pub. Date: Jun. 10, 2021

(54) METHOD FOR WELDING HARD MATERIAL BODIES TO TEETH OF A SAW BLADE

(71) Applicant: Credé Vermögensverwaltungs-GmbH + Co. KG, Pforzheim (DE)

(72) Inventor: Marcel Credé, Pforzheim (DE)

(73) Assignee: Credé Vermögensverwaltungs-GmbH + Co. KG, Pforzheim (DE)

(21) Appl. No.: 17/268,816

(22) PCT Filed: Aug. 15, 2019
(86) PCT No.: PCT/EP2019/071911

§ 371 Date: Feb. 16, 2021

(30) Foreign Application Priority Data
Aug. 20, 2018 (DE) 10 2018 120 242.3

(51) Int. Cl. B23K 31/02; B23D 61/04; B23D 65/00; B23K 11/00; B23K 11/14

(52) U.S. Cl. CPC B23K 31/025; B23D 61/04; B23K 11/14; B23K 11/002; B23D 65/00

(57) ABSTRACT

The invention relates to a method for welding hard material bodies to teeth of a saw blade, in particular of a band saw blade or circular saw blade, wherein each tooth has a joining surface, and each hard material body has a joining surface. The joining surface of the hard material body can be welded to the joining surface of the tooth. The method has the following steps:
bringing each tooth of the saw blade into a working region;
guiding each hard material body towards the tooth located in the working region;
advancing a welding device into the working region;
welding the hard material body to the tooth surface of the tooth located in the working region;
and withdrawing the welding device out of the working region. According to the invention, at least one welding introduction attachment which protrudes from the joining surface of the tooth is formed on each tooth or at least one welding introduction attachment which protrudes from the joining surface of the hard material body is formed on each hard material body. The welding introduction attachment is melted upon introducing a welding pulse.

### BACKGROUND

The invention relates to a method for welding hard material bodies to teeth of a saw blade, in particular of a band saw blade or circular saw blade, each tooth having a joining surface, and each hard material body having a joining surface, and it being possible to weld the joining surface of the hard material body to the joining surface of the tooth, and the method comprising the following steps:
bringing each tooth of the saw blade into a working region;
guiding each hard material body toward the tooth located in the working region;
advancing a welding device into the working region;
welding the hard material body to the joining surface of the tooth located in the working region, and
withdrawing the welding device out of the working region.

The invention also relates to a saw blade comprising teeth for welding hard material bodies thereto, and to a hard material body for welding to teeth of a saw blade.

In this case, a hard material body is understood to mean a body of any geometry, in particular a sphere, cylinder or plate shape, which is made of a hard material, in particular hard metal, cermet, cutting ceramic or diamond. The hard material body has, for example, a height of from 1 mm to 4.5 mm, preferably 1.5 mm to 3.5 mm, a width of from 1 mm to 6 mm, preferably 1.5 mm to 3.5 mm, and a length of from 2 mm to 6 mm, preferably 3 mm to 4.5 mm.

Methods for welding hard material bodies to teeth of saw blades are already known from the prior art. WO 2015/140345 A1 discloses a method of this kind, for example. It is usually desirable to weld the hard material bodies to the teeth of the saw blades with a high degree of accuracy. DE 10 2007 057 880 A1 also discloses a resistance-welded connection for cutting and grinding tools for connecting a cutting element of the tool to a carrier element. In the region of the connection zone, a plurality of protruding attachments are provided on the cutting element, which attachments are kept almost complete and unchanged when the cutting element is welded to the carrier element, such that the finished welded connection has an interlocking tooth-like course, in particular meandering course, in the joining direction.

### SUMMARY OF THE INVENTION

The problem addressed by the invention is that of providing an improved method for welding hard material bodies to teeth of a saw blade.

According to the invention, at least one welding introduction attachment protruding from the joining surface is formed on each tooth, or at least one welding introduction attachment protruding from the joining surface of the hard material body is formed on each hard material body, the welding introduction attachment being melted upon introducing a welding pulse.

By providing the welding introduction attachment, when the hard material body is guided toward the tooth, an abutment over a small surface area, i.e. a punctiform or linear abutment, is produced between the tooth and the hard material body, which are thereby held apart from one another at a distance corresponding approximately to the height of the welding introduction attachment before being welded to one another, wherein, as a result of the small surface area of this abutment, a relatively high electrical contact resistance is produced which is favorable for the introduction of heat into the workpieces by means of introducing a welding pulse. During the welding pulse, the welding introduction attachment is melted more and more and thereby, in the region of the joining surfaces, fuses with the tooth and the hard material body pressed thereon.

The thickness of the weld connection and the resulting height of the tooth together with a hard material body welded thereto are therefore specified to a certain extent by the welding introduction attachment.

The welding introduction attachment is advantageously pointed-cone-shaped, hemispherical, semicylindrical, drop-shaped, pea-shaped or pyramidal, and protrudes from a relevant joining surface. The height or length of the welding introduction attachment is 0.02 mm to 2 mm, preferably 0.05 mm to 0.8 mm, in particular 0.1 mm to 0.8 mm, such that the welding introduction attachment protrudes from the joining surface by 0.02 mm to 2 mm, preferably 0.05 mm to 0.8 mm, in particular 0.1 mm to 0.8 mm. The width of the welding introduction attachment is, for example, 0.1 mm to 3 mm, preferably 0.4 mm to 2 mm.

It proves particularly advantageous if the welding introduction attachment is elongate, in particular obliquely or orthogonally with respect to the saw blade plane, so as to form a type of rib or projection. In this way, it can be formed economically on the teeth of the saw blade by arranging a plurality of saw blades parallel to one another and then machining them in a transverse direction.

It can prove to be advantageous that each tooth comprises a tooth face and the joining surface of the tooth is formed on the tooth face of the relevant tooth such that each hard material body is welded to the tooth face of the relevant tooth. In the teeth of the saw blade, the tooth face is formed on a front side of a relevant tooth in a cutting direction, with the cutting direction meaning the direction in which the saw blade is moved relative to a workpiece to be sawed during a sawing process. The face of a relevant tooth therefore contacts a workpiece to be cut first.

The space available on the tooth face for welding the hard material body thereto is limited both by the height of the teeth and by the distance to the tooth preceding in the cutting direction, and is often limiting. It can prove to be advantageous that each tooth comprises a tooth back and the joining surface is formed on the tooth back of the relevant tooth such that each hard material body is welded to the tooth back of the relevant tooth. The tooth back is formed on the rear side of the tooth facing away from the cutting direction. There is typically more space available here.

According to a further concept of the invention, it proves advantageous for each hard material body to be ground, in particular to its final shape, in a step preceding the welding process. This can be done by the manufacturer or supplier of the hard material body.

In this case, grinding to its final shape is understood to mean that a desired cutting geometry, for example a cutting edge, is formed on the hard material body, such that no further grinding process is subsequently necessary after the welding process. Furthermore, with different types of saw blades it may sometimes be necessary to design individual teeth of a saw blade differently in a targeted manner. In this case, the final shapes of different hard material bodies can differ from one another. For example, saw blades comprising so-called pre-cutting and post-cutting geometry include teeth which have cutting edges of different widths, which are joined alternately one behind the other in the case of successive teeth.

In order to improve the cutting and/or sliding properties, it can prove to be advantageous for the hard material body to be coated in a further step preceding the welding process. The coating comprises, for example, titanium carbide (TiC), titanium nitride (TiN), titanium carbonitride (TiCN) or aluminum oxide (Al₂O₃). The coating can be carried out in a PVD or CVD process. In particular, it can prove to be advantageous that the hard material body is only partially coated, with no coating being provided in particular on the joining surface.

It can also prove advantageous that guiding each hard material body toward the tooth located in the working region comprises supplying and transferring the relevant hard material body onto the welding device by means of a supply device, in particular comprising a robot gripping device. The welding device, together with the hard material body transferred thereto, can then be advanced into the working region and guided toward the tooth located there.

In a further development of this concept of the invention in particular, it proves advantageous if the hard material bodies are provided in such a way that they can be easily gripped by means of the robot gripping device. For example, it is conceivable to hold the hard material bodies in line next to one another and/or stacked, for example in the manner of a matrix, in particular aligned depending on their geometry. In particular, it may be suitable to hold the hard material bodies in a magazine or in a blister.

In so doing, it is possible, for example, to grip hard material bodies that have already been ground in a certain orientation and to transfer said bodies to the welding device.

The invention also relates to a saw blade, in particular a band saw blade or circular saw blade, comprising teeth having a joining surface for welding hard material bodies thereto, at least one welding introduction attachment which protrudes from the relevant joining surface being formed on each tooth.

Each welding introduction attachment is advantageously pointed-cone-shaped, hemispherical, semicylindrical, drop-shaped, pea-shaped or pyramidal, and protrudes from a relevant joining surface.

It proves particularly advantageous that each welding introduction attachment is elongate, in particular obliquely or orthogonally with respect to the saw blade plane, so as to form a type of rib or projection.

The invention also relates to a hard material body for welding to teeth of a saw blade, having a joining surface, at least one welding introduction attachment which protrudes from the joining surface being formed.

### BRIEF DESCRIPTION OF THE DRAWINGS

Further advantages, features and details of the invention can be found in the dependent claims and in the following description, in which a preferred embodiment is described in detail with reference to the drawings. The features shown in the drawings and mentioned in the claims and in the description may in each case be essential to the invention individually or in any desired combination. In the drawings:

FIG. 1 is a schematic view of an apparatus comprising a saw blade for performing the method according to the invention from the side;

FIG. 2 is a view of the apparatus comprising the saw blade from above;

FIG. 3 is a detailed view of a first embodiment of the saw blade according to the invention together with a hard material body;

FIG. 4 is a detailed view of a second embodiment of the saw blade according to the invention together with a hard material body;

FIG. 5 shows an embodiment of the saw blade according to FIG. 3 without a hard material body;

FIG. 6 shows an embodiment of the saw blade according to FIG. 4 without a hard material body;

FIG. 7 shows a third embodiment of the saw blade according to the invention without a hard material body;

FIG. 8 shows a fourth embodiment of the saw blade according to the invention without a hard material body;

FIG. 9 is a schematic view of a hard material body according to the invention from the side, and

FIG. 10 is a view of the hard material body from FIG. 9 from the front.

### DETAILED DESCRIPTION

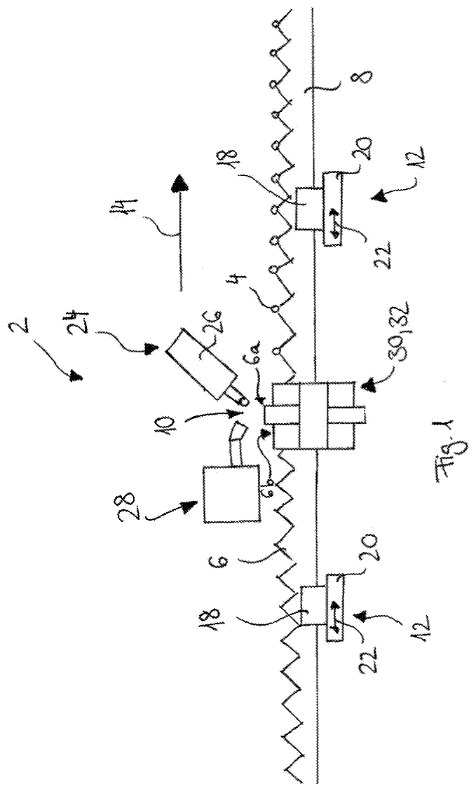

FIGS. 1 and 2 are schematic views of an apparatus, denoted as a whole by the reference sign 2, for welding hard material bodies 4 to teeth 6 of a saw blade 8, in a view from the side and in a view from above. In the embodiment shown, the saw blade 8 is a band saw blade. However, the invention can also be applied to circular saw blades. The saw blade 8, the teeth 6 of the saw blade 8 and the hard material bodies 4 welded thereto are only shown schematically in FIGS. 1 and 2.

The hard material bodies 4 are welded to the teeth 6 of the saw blade 8 in a working region 10 of the apparatus 2. For this purpose, the saw blade 8 is moved in a feed direction 14 by means of a saw blade feed device 12, such that a relevant intended tooth 6a of the saw blade 8 can be brought into the working region 10 of the apparatus 2. According to the embodiment shown, the saw blade feed device 12 comprises gripping or clamping devices 18 for grasping the saw blade 8 that are mounted on feed carriages 20. The feed carriages 20 can be moved, for example by means of a drive, in the direction of the double arrow 22 in parallel with the feed direction 14. The drive is preferably an electric linear drive. Moving the saw blade 8 in the feed direction 14 is understood to mean a translatory movement in the case of a band saw blade and naturally at least also a rotary movement in the case of a circular saw blade.

According to the embodiment shown, a welding device of the apparatus 2 for joining the hard material bodies 4 to the teeth 6 of the saw blade 8 is as a resistance welding device 24 comprising a welding electrode 26 that can be advanced into the working region 10 and withdrawn again out of the working region 10, such that the hard material bodies 4 are joined to the tooth backs 100 of the teeth 6 of the saw blade 8 by means of resistance welding.

By means of a supply device 28, each hard material body 4 is supplied to the welding electrode 26 and transferred thereto. The structure and the mode of operation of the supply device 28 are explained in the following with reference to FIG. 2. The welding electrode 26, together with the hard material body 4 transferred thereto, is advanced into the working region 10 of the apparatus 2, and the hard material body 4 is guided toward the tooth 6a of the saw blade 4.

The apparatus 2 according to the embodiment shown also comprises a first centering device 30 for centering the saw blade 8 transversely to the feed direction 14 before the welding process, and a second centering device 32 for centering each hard material body 4 transversely to the feed direction 14 before said body is welded to the relevant intended tooth 6a of the saw blade 8 located in the target position. The first and second centering devices 30, 32 can be formed by any actuating elements. Furthermore, the centering devices 30, 32 can each comprise a gripper arrangement comprising first gripper jaws which can be moved toward or away from one another transversely or obliquely with respect to the feed direction. The mode of operation and the structure of the first and second centering devices 30, 32 will not be discussed further at this point.

After the welding process has ended, the saw blade 8 is moved further in the feed direction 14 by means of the saw blade feed device 12, such that a subsequent tooth 6b can be brought into the target position.

In the following, the structure and mode of operation of the supply device 28 will now be explained with reference to FIG. 2. By means of a robot gripping device 34, hard material bodies 4 are gripped by a holding device 36 and transferred to the welding electrode 26. The holding device 36 is, for example, a plate on which the hard material bodies are held in line next to one another and/or stacked, for example in the manner of a matrix, in particular aligned depending on their geometry. Furthermore, it is also conceivable to hold the hard material bodies in a magazine or in a blister. The robot gripping device 34 grips a hard material body 4 from the holding device 36 and transfers it to the welding electrode 26, which then, together with the hard material body 4 transferred thereto, is guided toward the tooth 6a of the saw blade 8 located in the target position. The hard material body 4 is subsequently welded to the tooth back of the tooth 6a in a welding process. After the welding process has ended, the saw blade 8 is moved further in the feed direction 14 by means of the saw blade feed device 12, such that a subsequent tooth 6b can be brought into the target position. The robot gripping device 34 then grips a further suitable hard material body 4 from the holding device 36 and transfers it to the welding electrode 26.

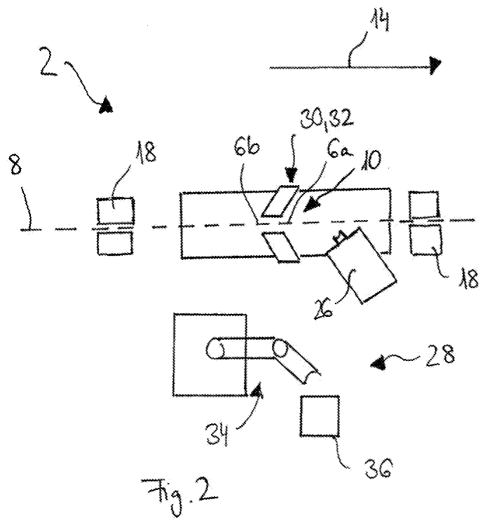

FIGS. 3 and 4 each show a detailed view of an embodiment of the saw blade 8 according to the invention comprising welded-on hard material bodies 4. According to the embodiment shown, the hard material bodies 4 are welded to tooth backs 100 of the teeth 6 of the saw blade.

The hard material body has, for example, a height H of from 1 mm to 4.5 mm, preferably 1.5 mm to 3.5 mm, a width of from 1 mm to 6 mm, preferably 1.5 mm to 3.5 mm, and a length L of from 2 mm to 6 mm, preferably 3 mm to 4.5 mm, the width of the hard material body according to the embodiment shown in FIGS. 3 and 4 being the extension of the hard material body orthogonal to the plane of the drawing.

According to the embodiments shown, the teeth 6 are aligned in the cutting direction 102, i.e. tips 104 of the teeth 6 point in the direction in which the saw blade 8 is to be moved relative to a workpiece (not shown) during the sawing process. The tooth back 100 is formed on the rear side 108 of the tooth 6 facing away from the cutting direction 102, a tooth face 110 being formed on the front side 112 of the tooth 6 in the cutting direction 102.

According to the embodiments shown in FIGS. 3 to 6, the tooth face 110 extends substantially approximately orthogonally to the cutting direction 102. The tooth back 100 extends at least in portions in an arc shape up to a foot 114 of the subsequent tooth 6. However, other configurations of the teeth 6 are also conceivable, in particular teeth 6 having a tooth face 110 inclined in the cutting direction 102 or teeth 6 having a tooth face 110 inclined away from the cutting direction 102.

According to FIGS. 3 and 4, each hard material body 4 is welded to the tooth back 100 of a relevant tooth 6, a joining surface 116 of the tooth 6 contacting a joining surface 118 of the hard material body. In FIG. 4, the joining surface 116 of the tooth is formed by a recess on the tooth back 100, which recess has an L-shaped profile in the side view.

FIGS. 5 to 8 each show a detailed view of various embodiments of the saw blade 8 according to the invention without a hard material body 4 joined to the teeth 6. According to the embodiment shown in FIG. 5, a welding introduction attachment 120 protruding from the joining surface 116 of the tooth 6 is formed on the tooth back 100 of each tooth 6 of the saw blade 8. According to the embodiment shown, the welding introduction attachment 120 is designed to taper to a point in the side view. The welding introduction attachment 120 can also have any other geometry. For example, the welding introduction attachment 120 can be pointed-cone-shaped, hemispherical, semicylindrical, drop-shaped, pea-shaped or pyramidal, and protrudes from the joining surface 116 of the tooth 6.

Due to the geometry of the welding introduction attachment 120, when the hard material body 4 is guided toward the tooth 6, an abutment over a small surface area, i.e. a punctiform or linear abutment, is produced between the tooth 6 and the hard material body 4, which are thereby held apart from one another at a distance corresponding approximately to the height of the welding introduction attachment 120 before being welded to one another, wherein, as a result of the small surface area of this abutment, a relatively high electrical contact resistance is produced which is favorable for the introduction of heat into the tooth 6 and hard material body 4 by means of introducing a welding pulse. During the welding pulse, the welding introduction attachment 120 is melted more and more and thereby, in the region of the joining surfaces 116, 118, fuses with the hard material body 4.

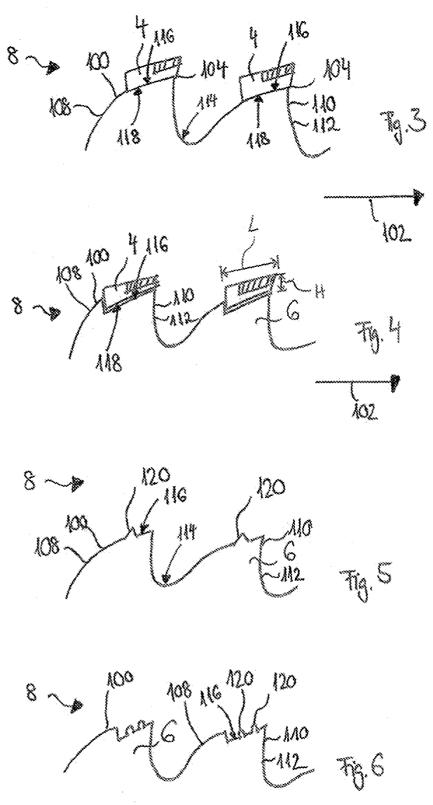

In principle, more than one welding introduction attachment 120 protruding from the joining surface 116 can also be formed on each tooth 6. FIG. 6 shows, by way of example, two welding introduction attachments 120 protruding from the joining surface 116 on the relevant tooth 6.

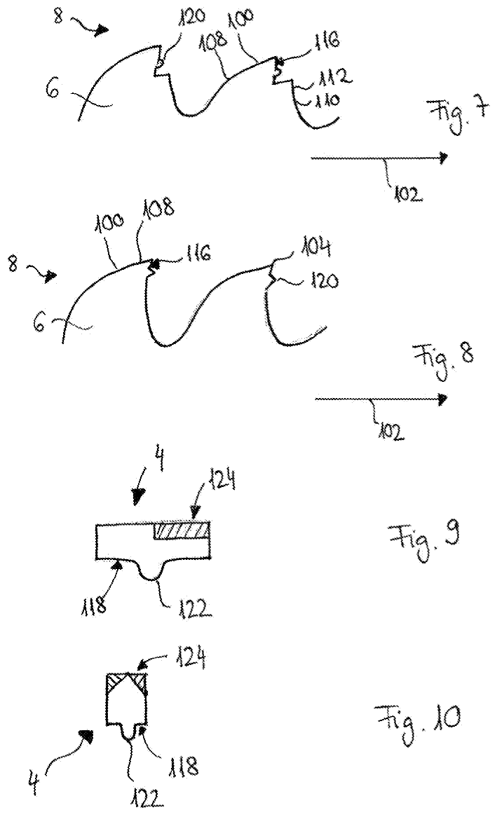

According to the embodiments shown in FIGS. 7 and 8, a relevant welding introduction attachment 120 protruding from the joining surface 116 of the relevant tooth 6 is formed on the tooth face 110. In the embodiment shown in FIG. 7, the joining surface 116 of the tooth is formed by a recess on the tooth face 110, which recess has an L-shaped profile in the side view.

Finally, FIGS. 9 and 10 show a schematic view, not to scale, of a hard material body 4 according to the invention. The hard material body 4 comprises a joining surface 118, by means of which the hard material body 4 can be welded to the joining surface 116 of a tooth 6 of the saw blade 8. A welding introduction attachment 122 protruding from the joining surface 118 is formed on the hard material body 4. Furthermore, an exemplary cutting geometry 124 is indicated in the embodiment shown. It is conceivable, for example, that the hard material body is ground to its final shape, i.e. is provided in particular with a cutting geometry 124, before being welded to the saw blade, such that no further grinding process is necessary after the welding process. Moreover, the geometry of the hard material body is shown here merely as an example.

1. A method for welding hard material bodies to teeth of a saw blade, each tooth having a joining surface, and each hard material body having a joining surface, and it being possible to weld the joining surface of the hard material body to the joining surface of the tooth, and the method comprising the following steps:
bringing each tooth of the saw blade into a working region;
guiding each hard material body toward the tooth located in the working region;
advancing a welding device into the working region;
welding the hard material body to the joining surface of the tooth located in the working region;
and withdrawing the welding device out of the working region, wherein at least one welding introduction attachment which protrudes from the joining surface of the tooth is formed on each tooth, or in that at least one welding introduction attachment which protrudes from the joining surface of the hard material body is formed on each hard material body, the welding introduction attachment being melted upon introducing a welding pulse.

2. The method according to claim 1, characterized in that the welding introduction attachment is one of pointed-cone-shaped, hemispherical, semicylindrical, drop-shaped, pea-shaped or pyramidal, and protrudes from a relevant joining surface.

3. The method according to claim 1, characterized in that the welding introduction attachment is elongate so as to form a type of rib or projection.

4. The method according to claim 1, characterized in that each tooth comprises a tooth face and the joining surface of the tooth is formed on the tooth face of the relevant tooth such that each hard material body is welded to the tooth face of the relevant tooth.

5. The method according to claim 1, characterized in that each tooth comprises a tooth back and the joining surface is formed on the tooth back of the relevant tooth such that each hard material body is welded to the tooth back of the relevant tooth.

6. The method according to claim 1, characterized in that each hard material body is ground to its final shape; in a step preceding the welding process.

7. The method according to claim 6, characterized in that the hard material body is coated in a further step preceding the welding process.

8. The method according to claim 1, characterized in that guiding each hard material body toward the tooth located in the working region comprises supplying and transferring the relevant hard material body onto the welding device by means of a supply device.

9. The method according to claim 1, characterized in that the hard material bodies are held in line next to one another and/or stacked in the manner of a matrix.

10. A saw blade, comprising teeth having a joining surface for welding hard material bodies thereto, characterized in that at least one welding introduction attachment protruding from the relevant joining surface is formed on each tooth of the saw blade.

11. The saw blade according to claim 10, characterized in that each welding introduction attachment is one of pointed-cone-shaped, hemispherical, semicylindrical, drop-shaped, pea-shaped or pyramidal, and protrudes from a relevant joining surface.

12. The saw blade according to claim 10, characterized in that each welding introduction attachment is elongate so as to form a type of rib or projection.

13. A hard material body for welding to teeth of a saw blade, having a joining surface, characterized in that at least one welding introduction attachment protruding from the joining surface is formed.
